(19) United States
(12) Patent Application Publication
(10) Pub. No.: US 2019/0112508 A1
(43) Pub. Date: Apr. 18, 2019

(54) Curable pressure-sensitive adhesive strip based on vinylaromatic block copolymer

(71) Applicant: TESA SE, Norderstedt (DE)

(72) Inventors: Thomas Schubert, Hamburg (DE); Michael MAYER, Hamburg (DE); Marten PAPENBROOCK, Hamburg (DE); Marta LUNDING, Norderstedt (DE); Julia GARBERS, Hamburg (DE)

(21) Appl. No.: 16/155,494

(22) Filed: Oct. 9, 2018

(30) Foreign Application Priority Data
Oct. 17, 2017 (DE) 10 2017 218 519.8

(51) Int. Cl. C09J 7/38; C09J 7/26; C09J 153/02

(52) U.S. Cl. CPC C09J 7/387; C09J 7/26; C09J 2205/31; C09J 2205/11; C09J 153/02

(57) ABSTRACT

The invention relates to a pressure-sensitive adhesive strip containing at least one layer SK1 of a self-adhesive composition based on vinylaromatic block copolymer and containing tackifying resin, wherein the vinylaromatic block copolymer
contains at least one polymer block A formed predominantly by polymerization of vinylaromatics, and
simultaneously contains at least one polymer block B formed predominantly by polymerization of conjugated dienes, where the proportion of 1,2-bonded conjugated diene in the B block is less than 30% by weight, preferably less than 20% by weight.

The invention also relates to a pressure-sensitive adhesive strip of this kind, in which at least layer SK1 has been subjected to irradiation with electrons.

The invention relates to a pressure-sensitive adhesive strip based on vinylaromatic block copolymer that can be cured by electron beams and is especially suitable for bonding of components having a nonpolar surface.

Adhesives and adhesive tapes are used in general to assemble two substrates in such a way as to form a lasting or permanent bond. In spite of a multiplicity of adhesives and adhesive tapes, innovative substrates and also heightened requirements with regard to the end-use application make it necessary to develop new pressure-sensitive adhesives, formulations and adhesive-tape designs. It has emerged, for instance, that new components in the field of automotive interiors, to which adhesive tapes are to adhere temporarily or permanently, are critical surfaces and pose a challenge to adhesive bonding. On account of the low surface energy of these components, there is a need for adhesive tapes designed especially for these applications.

Furthermore, in view of the ongoing trend in the transport sector and especially in the automotive industry to reduce further the weight of—for instance—a car and thus reduce the fuel consumption, the use of adhesive tapes is on the rise. As a result of this, adhesive tapes are being used for applications for which previous adhesive tape products were neither envisaged nor developed, and, in addition to the mechanical load and the critical substrates for adhesives applications, there are also increasing requirements especially for permanent bonds in respect of UV stability and weathering stability.

Consequently there exists the requirement for an adhesive tape product on the one hand to have enhanced adhesion to low-energy surfaces and on the other hand to preserve an outstanding performance profile even under extreme climatic conditions. Sufficient cohesion even at high temperatures is a particular requirement from the automotive industry especially in the case of permanent exterior bonds (emblems, bumpers), but also in the case of permanent interior bonds (doors).

The adhesive tape, additionally, is also required to suit the production operations. In view of ongoing automation of production operations and of the desire for more economical ways of manufacture, the adhesive tape, as soon as it has been positioned at the correct point, is required to quickly exhibit sufficiently high adhesion and in some cases to withstand high shear forces even at this juncture as well. For these purposes it is advantageous if the adhesive tapes exhibit high tack and the adhesives adapt rapidly to a variety of substrates, so that effective wetting and hence high bond strengths are achieved within a very short time.

Since the last aspect especially, namely a tendency to rapidly adapt to various surfaces, and hence the rapid attainment of constant bond forces, is difficult to achieve with resin-modified acrylate pressure-sensitive adhesives or straight acrylate pressure-sensitive adhesives, what are often described instead as suitable materials for bonding to non-polar surfaces are synthetic rubbers or blends with synthetic rubbers. EP 0 349 216 A1 and EP 0 352 901 A1 describe two-phase blends consisting of a polyacrylate and a synthetic rubber, preferably a styrene block copolymer, which are praised particularly for their bonding to paints and varnishes. Multiphase blend systems, however, can have the disadvantage that the morphology of the blend can alter over time and/or with increasing temperature, as manifested in a macroscopic change in the quality of the polymer and/or product. In extreme cases, moreover, there may be complete separation of the polymer components, and certain blend components may accumulate over time on surfaces, with a possible consequent change in adhesion. Since generally there is great cost and complexity involved—for example, through the use of compatibilizers as disclosed in U.S. Pat. No. 6,379,791 A—in producing blends for adhesive applications that exhibit long-term and thermal stability, these blend systems are not advantageous.

EP 2 226 369 A1 describes an adhesive tape which features a viscoelastic acrylate foam carrier clad with at least one layer of pressure-sensitive adhesive. The pressure-sensitive adhesive is based on a chemically crosslinked rubber, preferably a synthetic rubber crosslinked by means of electron beam curing. The adhesive tapes described there exhibit both good bond strengths to various paint and vamish films, and sufficient cohesion at high temperatures. It is nevertheless clearly apparent that these adhesive tapes display highly marked peeling characteristics, meaning that the high ultimate strengths required are not achieved until after several days. An adhesive tape of that kind, therefore, is unsuitable to rapid production operations.

EP 2832780 A1 relates to a pressure-sensitive adhesive foam comprising an elastomeric material based on rubber, at least one hydrocarbon tackifying resin and at least one crosslinker additive selected from the group of the multifunctional (meth)acrylate compounds. EP 2832779 A1 relates to a pressure-sensitive adhesive foam comprising an elastomeric material based on rubber and at least one hydrocarbon tackifying resin having a volatile organic compound (VOC) value of less than 1000 ppm and a volatile fogging compound (FOG) value of less than 1500 ppm. US 2014/0234612 A1 relates to a pressure-sensitive adhesive tape having an acrylic foam carrier and adhesive layers based on rubber on both sides of the carrier that have a gel content of 40% or more.

WO 00/06637 A1 relates to an article comprising a polymer foam having an essentially smooth surface with an Rₐ value of less than 75 micrometres, wherein the foam contains a multitude of microbeads, at least one of which is an expandable polymeric microbead.

Foamed pressure-sensitive adhesive composition systems have long been known and are described in the prior art. For example, they have lower densities than comparable unfoamed systems and typically feature nondestructive redetachability and repositionability. In principle, polymer foams can be produced in two ways. One way is via the effect of a blowing gas, whether added as such or resulting from a chemical reaction, and a second way is via incorporation of hollow beads into the material matrix. Foams that have been produced by the latter route are referred to as syntactic foams. In the case of a syntactic foam, hollow beads such as glass beads or hollow ceramic beads (microbeads) or microballoons are incorporated in a polymer matrix. As a result, in a syntactic foam, the voids are separated from one another and the substances (gas, air) present in the voids are divided from the surrounding matrix by a membrane. Compositions foamed with hollow microbeads are notable for a defined cell structure with a homogeneous size distribution of the foam cells. With hollow microbeads, closed-cell foams without voids are obtained, the features of which include better sealing action against dust and liquid media compared to open-cell variants. Furthermore, chemically or physically foamed materials have a greater propensity to irreversible collapse under pressure and temperature, and frequently show lower cohesive strength. Particularly advantageous properties can be achieved when the microbeads used for foaming are expandable microbeads (also referred to as “microballoons”). By virtue of their flexible, thermoplastic polymer shell, foams of this kind have higher adaptation capacity than those filled with non-expandable, non-polymeric hollow microbeads (for example hollow glass beads). They have better suitability for compensation for manufacturing tolerances, as is the rule, for example, in the case of injection-molded parts, and can also better compensate for thermal stresses because of their foam character.

DE 10 2008 004 388 A1 relates to a pressure-sensitive adhesive comprising expanded microballoons, wherein the bonding force of the adhesive comprising the expanded microballoons is reduced by comparison with the bonding force of an adhesive of identical basis weight and formulation that has been defoamed by the destruction of the cavities formed by the expanded microballoons by not more than 30%, preferably not more than 20%, more preferably 10%.

DE 10 2012 212 879 A1 relates to a pressure-sensitive adhesive comprising at least 70% by weight, preferably 80% by weight, of a mixture of

(i) block copolymers composed of a mixture of block copolymers having the structure I and II

A′-B′ I)

A-B-A, (A-B)ₙ, (A-B)ₙX and/or (A-B-A)ₙX, II)

where
X is the rest of a coupling reagent,
n is an integer from 2 to 10,
A and A′ is a polymer block formed from a vinylaromatic,
B and B′ is a polymer block formed from butadiene, a mixture of butadiene and isoprene and/or a mixture of butadiene and styrene, and
A and A′ or B and B′ may be the same or different,
   (ii) at least one tackifying resin,
   where the proportion of block copolymers I) is between 30% and 70% by weight based on the total amount of block copolymers,
   where the proportion of A in the block copolymers II) is between 25% and 40% by weight, and where the A-B unit within at least one of the vinylaromatic block copolymers of the structure II has a molecular weight M_{w} of greater than 65 000 g/mol and the molecular weight M_{w} of the overall block copolymer II is greater than 130 000 g/mol.

DE 10 2012 212 883 A1 relates to an adhesive tape having a carrier material composed of an acrylate-based foam layer to which at least one pressure-sensitive adhesive layer has been applied, wherein the pressure-sensitive adhesive (a) is composed of a mixture of at least two different synthetic rubbers, especially based on vinylaromatic block copolymers, (b) contains a resin which is insoluble in the acrylates that form the foam layer, and (c) is chemically uncrosslinked.

The as yet unpublished DE 10 2016 224 578 relates to a pressure-sensitive adhesive strip composed of at least three layers, comprising an inner layer F of a non-extensible film carrier, a layer SK1 of a self-adhesive composition disposed on one of the surfaces of the film carrier layer F and based on a vinylaromatic block copolymer composition foamed with microballoons, and a layer SK2 of a self-adhesive composition disposed on the opposite surface of the film carrier layer F from the layer SK1 and based on a vinylaromatic block copolymer composition foamed with microballoons, where the average diameter of the cavities formed by the microballoons in the self-adhesive composition layers SK1 and SK2 is in each case independently 20 to 60 μm. The pressure-sensitive adhesive strip has high shock resistance.

The likewise as yet unpublished DE 10 2016 224 735 relates to a pressure-sensitive adhesive strip comprising at least one layer SK1 of a self-adhesive composition based on a vinylaromatic block copolymer composition foamed with microballoons, where the average diameter of the cavities formed by the microballoons in the self-adhesive composition layer SK1 is 45 to 110 μm. The pressure-sensitive adhesive strip especially has a high lifetime under high-temperature shear.

WO 89/00106 A1 relates to an adhesive tape having a carrier layer comprising an electron beam-cured polymer matrix, about 5 to about 70 percent by volume of microbeads of low density, and at least one pigment in an amount sufficient to colour the tape.

US 2004/0131846 A1 relates to a pressure-sensitive adhesive tape comprising an electron beam-cured pressure-sensitive core based on rubber with polymeric microbeads and an electron beam-cured pressure-sensitive outer layer based on rubber which is essentially free of microbeads.

DE 10 2008 056 980 A1 relates to a self-adhesive composition consisting of a mixture comprising (i) a polymer blend of thermoplastic and/or non-thermoplastic elastomers with at least one vinylaromatic block copolymer containing a proportion greater than 30% by weight of 1,2-bonded diene in the elastomer block, at least one tackifying resin and expanded polymeric microbeads. The self-adhesive composition has the advantageous properties of a polymer matrix foamed with expanded microballoons. In addition, the vinylaromatic block copolymer can be crosslinked by means of electron beams in the elastomer block. It has been found that this radiation-chemical crosslinking can improve the cohesive properties of the foamed self-adhesive composition at high temperatures, with simultaneous retention of the adhesive properties. The proportion of 1,2-bonded diene in the elastomer block chosen here was greater than 30% by weight, since it is known to the person skilled in the art that 1,2-bonded diene units (called vinyl groups) are more reactive. It is correspondingly more difficult to induce elastomer blocks with a low proportion of 1,2-bonded diene to crosslink. However, a disadvantage of the self-adhesive composition is that the high proportion of greater than 30% by weight of 1,2-bonded diene in the elastomer block is accompanied at the same time by ageing instability in the vinylaromatic block copolymer.

The problem addressed by the present invention is thus that of providing an improved pressure-sensitive adhesive based on vinylaromatic block copolymers that has higher ageing stability and that can be used for production of a pressure-sensitively adhesive product having high thermal stability, especially lifetime under high-temperature shear.

The problem is surprisingly solved in accordance with the invention by a pressure-sensitive adhesive strip of the generic type as set out in Claim 1. Accordingly, the invention relates to a pressure-sensitive adhesive strip containing at least one layer SK1 of a self-adhesive composition based on vinylaromatic block copolymer and containing tackifying resin, wherein the vinylaromatic block copolymer
contains at least one polymer block A formed predominantly by polymerization of vinylaromatics, and
simultaneously contains at least one polymer block B formed predominantly by polymerization of conjugated dienes, where the proportion of 1,2-bonded conjugated diene in the B block is less than 30% by weight, preferably less than 20% by weight (determinable, for example, by means of ¹H NMR).

Particularly in order to increase the lifetime under high-temperature shear, the layer SK1 of the pressure-sensitive adhesive strip may be subjected to irradiation with electrons. The invention therefore further relates to a pressure-sensitive adhesive strip according to Claim 2, namely a pressure-sensitive adhesive strip containing at least one layer SK1 of a self-adhesive composition based on vinylaromatic block copolymer and containing tackifying resin, wherein the vinylaromatic block copolymer
contains at least one polymer block A formed predominantly by polymerization of vinylaromatics, and
simultaneously contains at least one polymer block B formed predominantly by polymerization of conjugated dienes, where the proportion of 1,2-bonded conjugated diene in the B block is less than 30% by weight, preferably less than 20% by weight, and where at least the layer SK1 has been subjected to irradiation with electrons.

Advantageous embodiments of the pressure-sensitive adhesive strip according to Claim 1 or Claim 2, and advantageous uses, can be found in the further claims.

The pressure-sensitive adhesive strip of the invention typically has the beneficial features not only of higher ageing stability but also improved mechanical properties (especially improved tensile strain properties and advantageous glass transition temperatures) and good bonding both to polar surfaces and to nonpolar, i.e. low-energy, surfaces. After irradiation with electrons, it also surprisingly has distinctly improved thermal stability, especially lifetime under high-temperature shear, even when no crosslinking promoter, for example

a polyfunctional (meth)acrylate, is added to the formulation. It has been found that the irradiation can improve cohesive properties at high temperatures, typically with simultaneously essential retention of the adhesive properties, such as the bonding force in particular, and mechanical properties, for example tensile strength. The improvement in cohesive properties found is surprising especially because the layer SK1 after irradiation with electrons has zero gel content and hence has no macroscopic or long-range crosslinking. The vinylaromatic block copolymer is accordingly not crosslinked after irradiation with electrons. Without being bound to the theory, it is suspected that the irradiation with electrons does not generate a complete network, but does generate local bonds. Surprisingly, layers SK1 with a marked thickness such as, in particular, 400 to 1500 μm can also be uniformly irradiated by electrons, meaning that the electron beam curing (EBC) even of such thick layers is possible in a uniform manner in spatial terms. Irradiation from both sides, i.e. symmetric irradiation, is advantageous in this respect.

The layer SK1 has preferably been foamed, for example with microballoons. The foaming of self-adhesive compositions, especially by means of microballoons, can not only save material costs, but typically also leads, for example, to an increase in the cohesion of the product, to improved bond strength on rough substrates, and elevated shock resistances. Alternatively, the layer SK1 may also be unfoamed.

According to the invention, what is typically meant by a self-adhesive composition “based on vinylaromatic block copolymer” is that predominantly the said polymer assumes the function of the elastomer component in the self-adhesive composition. Preferably, the said polymer is provided as the sole elastomer component in the self-adhesive composition or in any case, however, to an extent of at least 50% by weight based on the total content of all elastomer components.

According to the invention, the polymer block A of the vinylaromatic block copolymer has predominantly been formed by polymerization of vinylaromatics. This means that the block A has typically originated from a polymerization in which more than 50% by weight of the monomers used are vinylaromatics, meaning that the proportion of vinylaromatics in the polymerization is more than 50% by weight. Preferably, the polymer block A typically originates from a polymerization in which the monomers used have been exclusively vinylaromatics.

According to the invention, the polymer block B of the vinylaromatic block copolymer has been formed predominantly by polymerization of conjugated dienes. This means that the block B has typically originated from a polymerization in which more than 50% by weight of the monomers used are conjugated dienes, meaning that the proportion of conjugated diene in the polymerization is more than 50% by weight. Preferably, the polymer block B originates from a polymerization in which the monomers used have been exclusively conjugated dienes.

In addition, the proportion of 1,2-bonded conjugated diene in the B block is less than 30% by weight, preferably less than 20% by weight, more preferably less than 15% by weight and especially about 10% by weight. What is meant by the proportion of 1,2-bonded conjugated diene in the B block is the proportion by weight of conjugated diene that has been polymerized by 1,2 addition (as opposed to 1,4 addition), based on the overall monomer composition used in the preparation of the polymer block B. The 1,2 addition of conjugated diene leads to a vinylic side group in the polymer block B, whereas the 1,4 addition of conjugated diene leads to a vinylic functionality in the main chain of the polymer block B. The 1,2 addition of a conjugated diene thus means that the diene functionality is polymerized either at positions C1 and C2, or at positions C3 and C4 (for example in the case of isoprene as conjugated diene), as opposed to the 1,4 addition of a conjugated diene in which the diene functionality is polymerized at positions C1 and C4.

In a preferred embodiment, the pressure-sensitive adhesive strip does not comprise any (film) carrier. The pressure-sensitive adhesive strip here typically consist of a single self-adhesive composition layer SK1, and so the pressure-sensitive adhesive strip is a single-layer system. Such a single-layer adhesive tape which is self-adhesive on both sides, i.e. double-sided adhesive tape, is also referred to as “transfer tape”. Alternatively, the carrier-free pressure-sensitive adhesive strip, as well as layer SK1, may also contain at least one further layer which is not a carrier.

The self-adhesive composition of layer SK1 is a pressure-sensitive adhesive (PSA). The terms “self-adhesive” and “pressure-sensitively adhesive” are used synonymously in this respect within the scope of this document.

Pressure-sensitive adhesive compositions are especially those polymeric compositions which—if appropriate by suitable additization with further components, for example tackifying resins—are permanently tacky and adhesive at the use temperature (unless defined otherwise, at room temperature) and adhere on contact to a multitude of surfaces, and especially adhere immediately (have so-called “tack” [tackiness or touch-tackiness]). They are capable, even at the use temperature, without activation by solvent or by heat—but typically via the influence of a greater or lesser pressure—of sufficiently wetting a substrate to be bonded such that sufficient interactions for adhesion can form between the composition and the substrate. Influencing parameters that are essential in this respect include the pressure and the contact time. The exceptional properties of the pressure-sensitive adhesive compositions derive, inter alia, especially from their viscoelastic properties. For example, it is possible to produce weakly or strongly adhering adhesive compositions; and also those that can be bonded just once and permanently, such that the bond cannot be parted without destruction of the adhesive and/or the substrates, or those that can readily be parted again and, if appropriate, bonded repeatedly.

Pressure-sensitive adhesive compositions can in principle be produced on the basis of polymers of different chemical nature. The pressure-sensitive adhesive properties are affected by factors including the nature and the ratios of the monomers used in the polymerization of the polymers underlying the pressure-sensitive adhesive composition, the average molar mass and molar mass distribution thereof, and the nature and amount of the additives to the pressure-sensitive adhesive composition, such as tackifying resins, plasticizers and the like.

To achieve the viscoelastic properties, the monomers on which the polymers underlying the pressure-sensitive adhesive composition are based, and any further components present in the pressure-sensitive adhesive composition, are especially chosen such that the pressure-sensitive adhesive composition has a glass transition temperature (to DIN 53765) below the use temperature (i.e. typically below room temperature).

It may be advantageous in some cases, by suitable cohesion-enhancing measures, for example crosslinking reactions (formation of bridge-forming linkages between the macromolecules), to enlarge and/or to shift the temperature range in which a polymer composition has pressure-sensitive adhesive properties. The range of application of the pressure-sensitive adhesive compositions can thus be optimized via a setting between flowability and cohesion of the composition.

A pressure-sensitive adhesive composition has permanent pressure-sensitive adhesion at room temperature, i.e. has a sufficiently low viscosity and high touch-tackiness, such that it wets the surface of the respective adhesive substrate even at low contact pressure. The bondability of the adhesive composition is based on its adhesive properties, and the redetachability is based on its cohesive properties.

Self-Adhesive Composition Layers Usable in Accordance with the Invention

The layer SK1 of the pressure-sensitive adhesive strip of the invention is based on a vinylaromatic block copolymer composition.

The vinylaromatic block copolymer used in layer SK1 is preferably at least one synthetic rubber in the form of a block copolymer having an A-B, A-B-A, (A-B)ₙ, (A-B)ₙX or (A-B-A)ₙX structure,

in which
the A blocks are independently a polymer formed by polymerization of at least one vinylaromatic,
the B blocks are independently a polymer formed by polymerization of conjugated dienes having 4 to 18 carbon atoms,
X is the radical of a coupling reagent or initiator and
n is an integer ≥2.

More preferably, all synthetic rubbers in the self-adhesive composition layer of the invention are block copolymers having an A-B, A-B-A, (A-B)ₙ, (A-B)ₙX or (A-B-A)ₙX construction as set out above. The self-adhesive composition layer of the invention may thus also comprise mixtures of various block copolymers having a construction as described above.

Suitable block copolymers (vinylaromatic block copolymers) thus comprise one or more rubber-like blocks B (soft blocks) and one or more glass-like blocks A (hard blocks). More preferably, at least one synthetic rubber in the self-adhesive composition layer of the invention is a block copolymer having an A-B, A-B-A, (A-B)₂X, (A-B)₃X or (A-B)₄X construction, where the above meanings are applicable to A, B and X. Most preferably, all synthetic rubbers in the self-adhesive composition layer of the invention are block copolymers having an A-B, A-B-A, (A-B)₂X, (A-B)₃X or (A-B)₄X construction, where the above meanings are applicable to A, B and X. More particularly, the synthetic rubber in the self-adhesive composition layer of the invention is a mixture of block copolymers having an A-B, A-B-A, (A-B)₂X, (A-B)₃X or (A-B)₄X structure, preferably comprising at least diblock copolymers A-B and/or triblock copolymers A-B-A and/or (A-B)₂X.

Also advantageous is a mixture of diblock and triblock copolymers and (A-B)ₙ or (A-B)ₙX block copolymers with n not less than 3.

Also advantageous is a mixture of diblock and multiblock copolymers and (A-B)ₙ or (A-B)ₙX block copolymers with n not less than 3.

Particular preference is given to a mixture of linear block copolymers, such as, in particular, a mixture of diblock copolymers (A-B) and triblock copolymers (A-B-A). For example, it is possible to use two kinds of vinylaromatic block copolymers having a different weight ratio of diblock copolymers (A-B) and triblock copolymers (A-B-A). More preferably, self-adhesive compositions of the invention are based on styrene block copolymers; for example, the block copolymers of the self-adhesive compositions have polystyrene end blocks.

Vinylaromatic block copolymers utilized may thus, for example, be diblock copolymers A-B in combination with others among the block copolymers mentioned. It is possible to use the proportion of diblock copolymers to adjust the adaptation characteristics of the self-adhesive compositions and the bond strength thereof. Vinylaromatic block copolymer used in accordance with the invention preferably has a diblock copolymer content of 0% by weight to 70% by weight, more preferably of 15% by weight to 65% by weight, more preferably 30% to 60% by weight, and especially of 40% to 60% by weight, for example greater than 51.5% by weight to 55% by weight. A higher proportion of diblock copolymer in the vinylaromatic block copolymer leads to a distinct reduction in cohesion of the adhesive composition.

Commercially available block copolymer types frequently have a combination of polymers of different architecture. For example, Kraton D1101, nominally a linear polystyrene-polybutadiene triblock copolymer, according to the manufacturer (The Global Connection for Polymer and Compound Solution—Product and Application Guide, Kraton Performance Polymers, 2011), contains a diblock copolymer to an extent of 16% by weight. Kraton D1118, by contrast, a different polystyrene-polybutadiene block copolymer, contains a diblock copolymer to an extent of 78% by weight.

The block copolymers that result from the A and B blocks may contain identical or different B blocks. The block copolymers may have linear A-B-A structures. It is likewise possible to use block copolymers in radial form and star-shaped and linear multiblock copolymers. Further components present may be A-B diblock copolymers. All the aforementioned polymers can be utilized alone or in a mixture with one another.

In a vinylaromatic block copolymer used in accordance with the invention, such as a styrene block copolymer in particular, the proportion of polyvinylaromatics, such as polystyrene in particular, is preferably at least 12% by weight, more preferably at least 18% by weight and especially preferably at least 25% by weight, and likewise preferably at most 45% by weight and more preferably at most 35% by weight.

Rather than the preferred polystyrene blocks, vinylaromatics used may also be polymer blocks based on other aromatic-containing homo- and copolymers (preferably C₈ to C₁₂ aromatics) having glass transition temperatures of greater than 75° C., for example α-methylstyrene-containing aromatic blocks. In addition, it is also possible for identical or different A blocks to be present.

Preferably, the vinylaromatics for formation of the A block include styrene, α-methylstyrene and/or other styrene derivatives. The A block may thus be in the form of a homo- or copolymer. More preferably, the A block is a polystyrene.

Preferred conjugated dienes as monomers for the soft block B are especially selected from the group consisting of butadiene, isoprene, ethylbutadiene, phenylbutadiene, pentadiene, hexadiene, ethylhexadiene, dimethylbutadiene, α-farnesene and β-farnesene, and any mixture of these monomers. The B block may also be in the form of a homopolymer or copolymer. Particular preference is given to butadiene, isoprene or a mixture thereof. In particular, butadiene is used. Polybutadiene has better ageing characteristics compared to polyisoprene.

A blocks in the context of this invention are also referred to as “hard blocks”. B blocks, correspondingly, are also called “soft blocks” or “elastomer blocks”. This is reflected by the inventive selection of the blocks in accordance with their glass transition temperatures (for A blocks at least 25° C., especially at least 50° C., and for B blocks not more than 25° C., preferably not more than −25° C., and especially not more than −50° C.).

In general, a block architecture as described above can also be described as “hard block-soft block architecture”, even when vinylaromatic block copolymers are not involved.

The proportion of the vinylaromatic block copolymers, such as styrene block copolymers in particular, preferably based on the overall self-adhesive composition layer, totals at least 35% by weight. Too low a proportion of vinylaromatic block copolymers results in relatively low cohesion of the pressure-sensitive adhesive composition.

The maximum proportion of the vinylaromatic block copolymers, such as styrene block copolymers in particular, based on the overall self-adhesive composition, totals at most 75% by weight, preferably at most 65% by weight, further preferably at most 55% by weight. Too high a proportion of vinylaromatic block copolymers in turn results in barely any pressure-sensitive adhesion in the pressure-sensitive adhesive composition.

Accordingly, the proportion of the vinylaromatic block copolymers, such as styrene block copolymers in particular, based on the overall self-adhesive composition, preferably totals at least 35% by weight, and simultaneously at most 75% by weight, more preferably at most 65% by weight, most preferably at most 55% by weight.

The pressure-sensitive adhesion of the self-adhesive compositions can be achieved by addition of tackifying resins that are miscible with the elastomer phase. The self-adhesive compositions generally include, as well as the at least one vinylaromatic block copolymer, at least one tackifying resin in order to increase the adhesion in the desired manner. The tackifying resin should be compatible with the elastomer block of the block copolymers.

A “tackifying resin”, in accordance with the general understanding of the person skilled in the art, is understood to mean a low molecular weight oligomeric or polymeric resin that increases the adhesion (tack, intrinsic tackiness) of the pressure-sensitive adhesive composition compared to the pressure-sensitive adhesive composition that does not contain any tackifying resin but is otherwise identical.

Preferably, the tackifying resin chosen, to an extent of at least 75% by weight (based on the total resin content), is a resin having a DACP (diacetone alcohol cloud point) of greater than 0° C., preferably greater than 10° C., especially greater than 30° C., and a softening temperature (ring & ball) of not less than 70° C., preferably not less than 100° C. More preferably, the tackifying resin mentioned simultaneously has a DACP value of not more than 45° C. if no isoprene blocks are present in the elastomer phase, or of not more than 60° C. if isoprene blocks are present in the elastomer phase. More preferably, the softening temperature of the tackifying resin mentioned is not more than 150° C. More preferably, the tackifying resins comprise at least 75% by weight (based on the total resin content) of hydrocarbon resins or terpene resins or a mixture of the same.

It has been found that tackifiers advantageously usable for the pressure-sensitive adhesive composition(s) are especially nonpolar hydrocarbon resins, for example hydrogenated and non-hydrogenated polymers of dicyclopentadiene, non-hydrogenated, partly, selectively or fully hydrogenated hydrocarbon resins based on C₅, C₅/C₉ or C₉ monomer streams, and polyterpene resins based on α-pinene and/or β-pinene and/or δ-limonene. The aforementioned tackifying resins can be used either alone or in a mixture. It is possible to use either room temperature solid resins or liquid resins. Tackifying resins, in hydrogenated or non-hydrogenated form, which also contain oxygen, can optionally and preferably be used in the adhesive composition up to a maximum proportion of 25%, based on the total mass of the resins, for example rosins and/or rosin esters and/or terpene-phenol resins.

Hydrogenated hydrocarbon resins are particularly suitable in accordance with the invention since the absence of double bonds means that crosslinking cannot be disrupted.

In addition, however, it is also possible to use unhydrogenated resins, especially when crosslinking promoters, for example polyfunctional acrylates, are used. Particular preference is given to the use of terpene resins based on α-pinene (Piccolyte A series from Pinova, Dercolyte A series from DRT), since these, as well as high cohesion, also assure very high adhesion, even at high temperatures. But it is also possible to use other unhydrogenated hydrocarbon resins, unhydrogenated analogues of the above-described hydrogenated resins.

In a preferred embodiment, 20% to 60% by weight of at least one tackifying resin, based on the total weight of the self-adhesive composition layer, preferably 30% to 50% by weight of at least one tackifying resin, based on the total weight of the self-adhesive composition layer, is present in the self-adhesive composition layers.

For stabilization of the pressure-sensitive adhesive against ageing, primary antioxidants, for example sterically hindered phenols, secondary antioxidants, for example phosphite or thioethers, and/or carbon radical scavengers are frequently added. Since the vinylaromatic block copolymer used in accordance with the invention has a small proportion of 1,2-bonded conjugated diene in the B block, the pressure-sensitive adhesive strip of the present invention is comparatively stable to ageing even without addition of an ageing stabilizer. However, ageing stability can be further improved by addition of an ageing stabilizer. However, it should be taken into account that ageing stabilizers increase process complexity and have a tendency to migration or have a plasticizing effect.

Further additives used may typically be light stabilizers, for example UV absorbers and sterically hindered amines, antiozonants, metal deactivators, processing auxiliaries and end block-reinforcing resins.

Plasticizers, for example liquid resins (soft resins), plasticizer oils or low molecular weight liquid polymers, for example low molecular weight polyisobutylenes having molar masses of less than 1500 g/mol (number average) or liquid EPDM types may be used in small amounts of less than 20% by weight, such as, in particular, less than 5% by weight, based on the total mass of the self-adhesive composition. Preference is given to using Piccolyte® A25 from Pinova, a polyterpene resin of low molecular weight derived from α-pinene. Plasticizers, for example soft resins, have the particular advantage that they increase the tackiness of the self-adhesive composition. It has also been found that, surprisingly, very good thermal stabilities, for example service lives under high-temperature shear, can be achieved even when plasticizers are used in the self-adhesive composition layer of the invention after irradiation thereof with electrons.

Fillers, for example silicon dioxide, glass (ground or in the form of beads), aluminium oxides, zinc oxides, calcium carbonates, titanium dioxide, carbon blacks, etc., and likewise colour pigments and dyes (colourants) and also optical brighteners may likewise be used. Colourant carriers used may, for example, be ethylene-vinyl acetate copolymer or other materials, especially thermoplastic materials; alternatively, it is also possible to use aqueous colourants such as, dispersions.

For an increase in the radiation yield, crosslinking promoters are optionally used for the electron beam curing. Crosslinking promoters used may, for example, be crosslinking promoters based on multifunctional acrylates or thiols. However, it has been found that, surprisingly, in spite of the small proportion of 1,2-bonded conjugated diene in the polymer block B of the vinylaromatic block copolymer used, the corresponding self-adhesive composition layer can be cured with electrons by irradiation even without additional crosslinking promoter, so as to give a layer having high lifetime under high-temperature shear. The omission of the crosslinking promoter lowers costs and complexity in the production of the pressure sensitive adhesive strip of the invention. Preference is therefore given in accordance with the invention to using those pressure-sensitive adhesive strips that do not contain any crosslinking promoter.

In a preferred embodiment of the invention, the adhesive composition consists solely of vinylaromatic block copolymers, tackifying resins, microballoons and optionally the abovementioned additives.

Further preferably, the adhesive composition consists of the following composition:

| | |
|---|---|
| vinylaromatic block copolymers | 35% to 65% by weight |
| tackifying resins | 34.6% to 45% by weight |
| microballoons | 0.2% to 10% by weight |
| additives | 0.2% to 10% by weight |

Further preferably, the adhesive composition consists of the following composition:

| | |
|---|---|
| vinylaromatic block copolymers | 35% to 75% by weight |
| tackifying resins | 24.8% to 60% by weight |
| microballoons | 0.2% to 10% by weight |

The self-adhesive composition SK1 of the invention has preferably been foamed.

In principle, foams can be produced in two ways. One way is via the effect of a blowing gas, whether added as such or resulting from a chemical reaction, and a second way is via incorporation of hollow beads into the material matrix. Foams that have been produced by the latter route are referred to as syntactic foams.

Physical blowing agents that are useful in the present application are any naturally occurring atmospheric materials that are gaseous at the temperature and pressure at which the foam exits the nozzle. Physical blowing agents can be introduced, i.e. injected, into the polymer mixture material as a gas, as a supercritical fluid or as a liquid. The choice of physical blowing agent used depends on the desired properties in the resulting foams. Other factors that are taken into account in the selection of a blowing agent are its toxicity, its vapour pressure profile, its simplicity of handling and its solubility in relation to the polymeric materials used. Flammable blowing agents such as pentane, butane and other organic materials such as hydrofluorocarbons and hydrochlorofluorocarbons may be used, but preference is given to noncombustible, non-toxic, non-ozone-degrading blowing agents because they are easier to use, for example there are fewer concerns with regard to the environment, etc. Suitable physical blowing agents are, for example, carbon dioxide, nitrogen, SF₆, nitrogen oxides, perfluorinated liquids such as C₂F₆, noble gases such as helium, argon and xenon, air (typically a mixture of nitrogen and oxygen), and mixtures of these materials.

Alternatively, it is also possible to use chemical blowing agents in the foam. Suitable chemical blowing agents include a mixture of sodium bicarbonate and citric acid, dinitrosopentamethylenetetramine, p-toluenesulfonyl hydrazide, 4,4′-oxybis-(benzenesulfonyl hydrazide), azodicarbonamide (1,1′-azobisformamide), p-toluenesulfonyl semicarbazide, 5-phenyltetrazole, 5-phenyltetrazole analogues, diisopropyl hydrazodicarboxylate, 5-phenyl-3,6-dihydro-1,3,4-oxadiazin-2-one and sodium borohydride.

In the case of a syntactic foam, microbeads such as glass beads or ceramic hollow beads or microballoons have been incorporated in a polymer matrix. As a result, in a syntactic foam, the voids are separated from one another and the substances (gas, air) present in the voids are divided from the surrounding matrix by a membrane.

Compositions foamed with hollow microbeads are notable for a defined cell structure with a homogeneous size distribution of the foam cells. With hollow microbeads, closed-cell foams without voids are obtained, the features of which include better sealing action against dust and liquid media compared to open-cell variants. Furthermore, chemically or physically foamed materials have a greater propensity to irreversible collapse under pressure and temperature, and frequently show lower cohesive strength.

Particularly advantageous properties can be achieved when the microbeads used for foaming are expandable microbeads (also referred to as “microballoons”). By virtue of their flexible, thermoplastic polymer shell, foams of this kind have higher adaptation capacity than those filled with non-expandable, non-polymeric hollow microbeads (for example hollow glass beads). They have better suitability for compensation for manufacturing tolerances, as is the rule, for example, in the case of injection-moulded parts, and can also better compensate for thermal stresses because of their foam character.

Preferably, the foaming is therefore in each case effected by the introduction and subsequent expansion of microballoons, meaning that the self-adhesive composition of layer SK1 has preferably been foamed with microballoons.

“Microballoons” are understood to mean hollow microbeads that are elastic and hence expandable in their ground state, having a thermoplastic polymer shell. These beads have been filled with low-boiling liquids or liquefied gas. Shell material employed is especially polyacrylonitrile, PVDC, PVC or polyacrylates. Suitable low-boiling liquids are especially hydrocarbons from the lower alkanes, for example isobutane or isopentane, that are enclosed in the polymer shell under pressure as liquefied gas.

Action on the microballoons, especially by the action of heat, results in softening of the outer polymer shell. At the same time, the liquid blowing gas present within the shell is converted to its gaseous state. This causes irreversible extension and three-dimensional expansion of the microballoons. The expansion has ended when the internal and external pressure are balanced. Since the polymeric shell is conserved, what is achieved is thus a closed-cell foam.

A multitude of unexpanded microballoon types is commercially available, which differ essentially in terms of their size and the starting temperatures that they require for expansion (75 to 220° C.). One example of commercially available unexpanded microballoons is the Expancel® DU products (DU=dry unexpanded) from Akzo Nobel. In the product designation Expancel xxx DU yy (dry unexpanded), “xxx” represents the composition of the microballoon mixture, and “yy” the size of the microballoons in the expanded state.

Unexpanded microballoon products are also available in the form of an aqueous dispersion having a solids/microballoon content of about 40% to 45% by weight, and additionally also in the form of polymer-bound microballoons (masterbatches), for example in ethylene-vinyl acetate with a microballoon concentration of about 65% by weight. Both the microballoon dispersions and the masterbatches, like the DU products, are suitable for production of a foamed self-adhesive composition of the invention.

A foamed self-adhesive composition SK1 of the invention can also be produced with what are called pre-expanded microballoons. In the case of this group, the expansion already takes place prior to mixing into the polymer matrix. Pre-expanded microballoons are commercially available, for example, under the Dualite® name or with the product designation Expancel xxx DE yy (dry expanded) from Akzo Nobel. “xxx” represents the composition of the microballoon mixture; “yy” represents the size of the microballoons in the expanded state.

In the processing of already expanded microballoon types, it is possible that the microballoons, because of their low density in the polymer matrix into which they are to be incorporated, will have a tendency to float, i.e. to rise “upward” in the polymer matrix during the processing operation. This leads to inhomogeneous distribution of the microballoons in the layer. In the upper region of the layer (z direction), more microballoons are to be found than in the lower region of the layer, such that a density gradient across the layer thickness is established.

In order to largely or very substantially prevent such a density gradient, preference is given in accordance with the invention to incorporating only a low level of, if any, pre-expanded microballoons into the polymer matrix of layer SK1. Only after the incorporation into the layer are the microballoons expanded. In this way, a more homogeneous distribution of the microballoons in the polymer matrix is obtained.

Preferably, the microballoons are chosen such that the ratio of the density of the polymer matrix to the density of the (non-pre-expanded or only slightly pre-expanded) microballoons to be incorporated into the polymer matrix is between 1 and 1:6. Expansion then follows immediately after or occurs directly in the course of incorporation. In the case of solvent-containing compositions, the microballoons are preferably expanded only after incorporation, coating, drying (solvent evaporation). Preference is therefore given in accordance with the invention to using DU products.

According to the invention, the average diameter of the voids formed by the microballoons in the foamed self-adhesive composition layer SK1 is preferably 20 to 150 μm, more preferably 20 to 50 μm, for example 40 to 45 μm. In the range from 20 to 50 μm, the microballoons lead to particularly high shock resistances of the self-adhesive composition layers.

Since it is the diameters of the voids formed by the microballoons in the foamed self-adhesive composition layers that are being measured here, the diameters are those diameters of the voids formed by the expanded microballoons. The average diameter here is the arithmetic average of the diameters of the voids formed by the microballoons in the respective self-adhesive composition layer SK1.

If foaming is effected by means of microballoons, the microballoons can then be supplied to the formulation as a batch, paste or unblended or blended powder. In addition, they may be suspended in solvents.

The proportion of the microballoons in the self-adhesive composition layer SK1, in a preferred embodiment of the invention, is up to 12% by weight, preferably between 0.25% by weight and 5% by weight, more preferably between 0.5% and 4% by weight, even more preferably between 1% by weight and 3.5% by weight, and especially 2.0% to 3.0% by weight, based in each case on the overall composition of the self-adhesive composition layer. Within these ranges, it is possible to provide self-adhesive composition layers that typically have a particularly good balance between adhesion and cohesion.

A self-adhesive composition SK1 of the invention, comprising expandable hollow microbeads, may additionally also contain non-expandable hollow microbeads. What is crucial is merely that virtually all gas-containing caverns are closed by a permanently impervious membrane, no matter whether this membrane consists of an elastic and thermoplastically extensible polymer mixture or, for instance, of elastic and—within the spectrum of the temperatures possible in plastics processing—non-thermoplastic glass.

Also suitable for the self-adhesive composition of the invention—selected independently of other additives—are solid polymer beads, hollow glass beads, solid glass beads, hollow ceramic beads, solid ceramic beads and/or solid carbon beads (“carbon microballoons”).

The absolute density of a foamed self-adhesive composition layer SK1 of the invention is preferably 400 to 990 kg/m³, more preferably 450 to 800 kg/m³, even more preferably 500 to 700 kg/m³ and especially 500 to 600 kg/m³.

### Configuration and Production of the Pressure-Sensitive Adhesive Strip

1. Configuration of the Pressure-Sensitive Adhesive Strip:

Preferably, all layers of the pressure-sensitive adhesive strip are essentially in the shape of a cuboid. Further preferably, all layers are bonded to one another over the full area. This bond can be optimized by the pretreatment of the film surfaces.

The general expression “adhesive strip” (pressure-sensitive adhesive strip), or else synonymously “adhesive tape” (pressure-sensitive adhesive tape), in the context of this invention, encompasses all sheetlike structures such as films or film sections extending in two dimensions, tapes having extended length and limited width, tape sections and the like, and lastly also die-cut parts or labels.

The pressure-sensitive adhesive strip thus has a longitudinal extent (x direction) and a lateral extent (y direction). The pressure-sensitive adhesive strip also has a thickness (z direction) that runs perpendicular to the two extents, the lateral extent and longitudinal extent being several times greater than the thickness. The thickness is very substantially the same, preferably exactly the same, over the entire areal extent of the pressure-sensitive adhesive strip determined by its length and width.

The pressure-sensitive adhesive strip of the invention is especially in sheet form. A sheet is understood to mean an object, the length of which (extent in the x direction) is several times greater than its width (extent in the y direction), and the width over the entire length remains roughly and preferably exactly the same.

Typical supply forms of the pressure-sensitive adhesive strips of the invention are adhesive tape rolls in any conceivable dimension, spools with long running length and different widths, bales, rods and adhesive strips as obtained, for example, in the form of die-cut parts.

Preference is given to die-cut parts in all conceivable sizes and shapes, for example in the form of a solid die-cut part with identical or different edge lengths, round or sharp edges or else specially adapted forms, but also in the form of die-cut frames in all conceivable sizes, shapes and land widths. The size of the die-cut part can be used to adjust the holding power of the individual connection site. The die-cut parts may lie directly on the liner without being covered by a further liner on the other side, and are sent as such to the processing. In this case, the component should be processed further directly. Alternatively, the die-cut parts may have been provided on the open side with an additional matched liner with or without a finger-tab. In this case, storage, dispatch or the like may take place.

It is generally an option to apply die-cut parts or to bond them to components by means of machine-automated processes. In this case, it is possible to remove any liner still present if required.

In addition, the adhesive tape may already have been cut into segments on rolls, as for example for installation of cabling in the automotive sector. This enables individual pieces to be pulled off from the liner. By contrast with the customary die-cut parts, however, the pieces here are adjacent on the liner and hence always rectangular.

Adhesive tapes of the invention that have been coated with adhesives on one or both sides are usually wound at the end of the production process to give a roll in the form of an Archimedean spiral. In order to prevent the pressure-sensitive adhesives from coming into contact with one another in the case of double-sidedly adhesive tapes, or in order to assure easier unrolling in the case of single-sidedly adhesive tapes, the adhesive is covered with a cover material (also referred to as release material) prior to the winding of the adhesive tape. The person skilled in the art knows such covering materials by the name of release liner or liner. As well as the covering of single- or double-sided adhesive tapes, liners are also used to cover labels. A liner (release paper, release film) is not part of a pressure-sensitive adhesive strip, but merely an auxiliary for production and/or storage thereof and/or for further processing by die-cutting. Furthermore, a liner, by contrast with an adhesive tape carrier, is not firmly bonded to an adhesive layer. The release liner additionally ensures that the adhesive is not soiled prior to use. In addition, release liners can be adjusted via the type and composition of the release materials such that the adhesive tape can be unrolled with the desired force (light or heavy). In the case of adhesive tapes double-sidedly coated with adhesive, the release liners additionally ensure that the correct side of the adhesive is exposed first in the unrolling operation.

Release liners used are typically paper or film carriers that have been provided on one or especially both sides with an abhesive coating composition (also referred to as dehesive or anti-adhesive composition) in order to reduce the tendency of adhering products to adhere to these surfaces (separating function). Abhesive coating compositions used, which are also called release coating, may be a multitude of different substances: waxes, fluorinated or partly fluorinated compounds and especially silicones, and various copolymers having silicone components. In the last few years, silicones have become largely established as release materials in the field of adhesive tape application owing to their good processibility, low costs and broad profile of properties.

In order to facilitate the removal of a release liner from the adhesive tape that generally takes place directly prior to application, the liners are occasionally provided with gripping aids called “tabs”, on their reverse side (the unrolling side). This makes it easier to pull the liner off in that it is not necessary first to penetrate between liner and adhesive in order to be able to grip a piece of liner and subsequently to be able to pull the liner further off; instead, it is sufficient to grip the tab to be able to remove the liner without difficulty. For this purpose, the tabs are welded or stuck onto the reverse side of the liner in such a way that a grippable part of the tab is not bonded to the liner but protrudes from its surface or lies loose thereon. Gripping aids of this kind are described, for example, in EP 2 426 185 A1.

Double-sided adhesive tapes, if required, are wound up to give a cross-wound longitudinal roll, also called spool, and therefore frequently provided with a further release liner on one side in the production and storage thereof. This further release liner, frequently referred to as “auxiliary liner” or else as “interliner”, generally has an overlap at either side by comparison with the width of the adhesive tape and can therefore prevent, inter alia, sticking of the lateral edges of the wound adhesive tape to one another, also called blocking.

The pressure-sensitive adhesive strip of the invention may also be a double-sided adhesive tape comprising a pressure-sensitive adhesive composition layer SK1 of the invention, as defined above, and a heat-activatable adhesive layer, wherein the pressure-sensitive adhesive composition layer has been covered with a release liner. Double-sided adhesive tapes of this kind with a heat-activatable adhesive layer are generally wound up to form a cross-wound longitudinal roll or spool as described above, in which case the interliner is generally on the side of the heat-activatable layer.

Various product constructions are conceivable with regard to the pressure-sensitive adhesive strip. Always present is at least one layer SK1 of a self-adhesive composition of the invention. The layer SK1 may have a thickness of 15 to 5000 μm, preferably 50 to 3000 μm, more preferably 100 μm to 2000 μm, even more preferably 150 μm to 2000 μm, even more preferably 400 to 1500 μm, especially 400 to 900 μm, for example 500 to 800 μm. Further layers may be present in the pressure-sensitive adhesive strip, for example further adhesive layers. In addition, it is possible for non-tacky layers, which are especially understood to mean carrier layers of low extensibility (εₘₐₓ<100%) or extensible carrier layers (εₘₐₓ at least 100%), to be present in the pressure-sensitive adhesive strip.

The release liner of the invention preferably has a good balance between strength and flexibility. Firstly, its strength is to counteract overextension or stretching of the adhesive tape in the course of processing and application; secondly, it is also to be flexible enough to be able to apply the adhesive tape together with the release liner even in the form of a curve without crease formation. Preferably, the release liner is additionally also dimensionally stable at elevated temperatures. This enables, inter alia, direct coating of the release liner with a pressure-sensitive adhesive processed by the hotmelt method directly after processing, without any disadvantageous changes in shape of the release liner, meaning that such a release liner is directly coatable. Such a release liner for use on pressure-sensitive adhesives is, for example, a release liner comprising the following layers:
an outer silicone release layer (SR),
a ply (POL) which, in each of its layers, contains a total of at least 50% by weight, based in each case on the total weight of the layer, of one or more polyolefins,
   where the ply (POL) contains at least 60% by weight, based on the total weight of the ply (POL), of polypropylene, and
an outer layer (PER) containing at least 80% by weight, based on the total weight of the layer (PER), of polyethylene, where the layer (PER) is bonded by an adhesive to the next layer in the construction of the release liner.

Preferably, the release liner has additionally been provided with a gripping aid and can be pulled off therewith from the adhesive without difficulty. For example, it is optionally possible to thermally weld one or more grip tabs, for example made of a PET/PE composite or an aluminium/PET/PE composite, to the release liner of the invention. Such a liner can subsequently be pulled off from pressure-sensitive adhesives without difficulty without thereby impairing the composite composed of grip tab and liner or the layer composite of the liner.

If the dibiock content within the elastomer component is below 50%, it is also possible to obtain products, especially transfer tapes, that can be detached again essentially without residue from a bonded joint or from a surface by stretching. For prior art with regard to products redetachable by stretching, reference is made to WO 2017/064167 A1 and documents cited therein.

2. Production of the Pressure-Sensitive Adhesive Strip:

The pressure-sensitive adhesive strip of the invention as defined in Claim 1 can be produced either from solution or from the melt. The application of the self-adhesive composition SK1 usable in accordance with the invention to a liner can be effected by direct coating or by lamination, especially hot lamination.

In an illustrative solvent process for producing a transfer tape of the invention, i.e. a pressure-sensitive adhesive strip composed of a single self-adhesive composition layer SK1, all constituents of the adhesive are dissolved in a solvent mixture, for example benzine/toluene/acetone. The microballoons, if any are being used, are typically suspended in benzine and stirred into the dissolved adhesive. For this purpose, it is possible in principle to use the known compounding and stirring units, and it should be ensured that the microballoons do not yet expand in the course of mixing. As soon as the microballoons are distributed homogeneously in the solution, the adhesive composition can be coated, for which it is again possible to use prior art coating systems. For example, the coating can be accomplished by means of a doctor blade onto a conventional PET liner. In the next step, the coating of adhesive composition is dried, for example, at 100° C. for 15 min. The drying temperature chosen is especially lower than the expansion temperature in order to avoid the expansion of the microballoons in the course of drying. In none of the aforementioned steps, therefore, is there any expansion of the microballoons. After the drying, the adhesive layer is covered with a second ply of liner, for example PET liner, and foamed in the oven within an appropriate temperature/time window, for example at 150° C. for 5 min or at 170° C. for 1 min, specifically covered between the two liners in order to produce a particularly smooth surface.

Alternatively, a transfer tape of the invention can be produced from the melt. With the hotmelt processes of the invention, solvent-free processing of all previously known components of adhesive compositions and those described in the literature, especially self-adhesive components, is possible. Presented hereinafter by way of example are some hotmelt processes for production of a transfer tape of the invention, the transfer tape of the invention being foamed in each case with microballoons.

For instance, the invention includes a process for producing a transfer tape of the invention, wherein
the constituents for formation of an adhesive composition, such as polymers, resins or fillers and non-expanded microballoons, are mixed in a first mixing unit and heated to expansion temperature under elevated pressure,
the microballoons are expanded on exit from the mixing unit,
the adhesive composition mixture along with the expanded microballoons is formed to a layer in a roll applicator,
the adhesive composition mixture along with the expanded microballoons is optionally applied to a release material in sheet form.

The invention likewise includes a process for producing a transfer tape of the invention, wherein
the constituents for formation of an adhesive composition, such as polymers, resins and optionally fillers, are mixed in a first mixing unit, and non-expanded microballoons and optionally also fillers are mixed in a second mixing unit and heated to expansion temperature under elevated pressure in the second mixing unit,
the microballoons are expanded on exit from the mixing unit,
the adhesive composition mixture along with the expanded microballoons is formed to a layer in a roll applicator,
the adhesive composition mixture along with the expanded microballoons is optionally applied to a release material in sheet form.

Particular preference is given to a process in which one of the units is a planetary roll extruder which has especially also been equipped with at least one degassing apparatus in the form of a gas-permeable side-arm extruder. Optionally and preferably, the planetary roll extruder has a further additional degassing apparatus upstream of the first degassing apparatus at the site of addition of the constituents for formation of the adhesive. It is surprising that such a unit offers advantages in the processing of block copolymers, for example styrene block copolymers (SBCs). Block copolymers soften above the melting or softening temperature of their hard blocks and then have a low viscosity, and so degassing in the highly liquefied state does not seem obvious since excessive egress out of the side-arm extruder is to be expected. Surprisingly, the planetary roll extruder with degassing apparatus, however, offers sufficient cooling performance to nevertheless compound and to degas block copolymers such as styrene block copolymers in a single planetary roll extruder. A particularly preferred process is found to be one in which, in a first process zone, a wall temperature above the melting or softening temperature (measured by means of DSC) of the styrene blocks is established and, in at least a second zone downstream, a temperature below the melting or softening temperature of the styrene blocks is established. The temperature of the central spindle can be chosen suitably, but is usually between these temperatures or below the melting or softening temperature of the styrene blocks. It is obvious that this process is also suitable for comparable block copolymers with hard block-soft block architecture, provided that the hard block is softenable or fusible. This process is particularly suitable when the proportion of such block copolymers is at least 35% by weight of the adhesive formulation, and most preferably at least 40% by weight, and/or at least one tackifying resin is present.

Particular preference is thus given to a process for producing an adhesive composition, preferably a pressure-sensitive adhesive composition, such as, in particular, a self-adhesive composition as defined in Claim 1, based on block copolymers having hard block-soft block architecture, in which
the hard blocks are softenable or fusible at a temperature T (measured by means of DSC),
wherein the process is conducted in a planetary roll extruder, and
wherein a wall temperature above the melting or softening temperature T of the hard blocks is established in a first process zone of the planetary roll extruder, and
a wall temperature below the melting or softening temperature T of the hard blocks is established in at least a second process zone downstream, and
wherein the planetary roll extruder, downstream of the addition of the components of the adhesive, has a degassing apparatus in the form of a gas-permeable side-arm extruder.

Particular preference is also given to a process for producing an adhesive composition, preferably a pressure-sensitive adhesive composition, such as, in particular, a self-adhesive composition as defined in Claim 1, based on block copolymers having hard block-soft block architecture, in which
the hard blocks are softenable or fusible at a temperature T (measured by means of DSC),
wherein the process is conducted in a planetary roll extruder, and
wherein a wall temperature above the melting or softening temperature T of the hard blocks is established in a first process zone of the planetary roll extruder, and
wherein expandable microballoons that foam in this zone are added upstream of or in this zone, and wherein
a wall temperature below the melting or softening temperature T of the hard blocks is established in at least a second process zone downstream, and
wherein the planetary roll extruder, downstream of the addition of the components of the adhesive, has a degassing apparatus in the form of a gas-permeable side-arm extruder.

More particularly, these above processes are preferably employed in the production of the pressure-sensitive adhesive strip of the invention in the different configurations.

The invention additionally includes a process for producing a transfer tape of the invention, wherein
the constituents for formation of an adhesive composition, such as polymers, resins or fillers and non-expanded microballoons, are mixed in a first mixing unit and heated to expansion temperature,
the microballoons expand at least partly during mixing, and are preferably expanded fully,
the adhesive composition mixture along with the expanded microballoons is formed to a layer in a roll applicator,
the adhesive composition mixture along with the expanded microballoons is optionally applied to a release material in sheet form.

The invention likewise includes a process for producing a transfer tape of the invention, wherein
the constituents for formation of an adhesive composition, such as polymers, resins or fillers, together with non-expanded microballoons, are mixed in a first mixing unit under elevated pressure and heated to a temperature below the expansion temperature of the microballoons,
the mixed, especially homogeneous adhesive composition from the first mixing unit is transferred into a second unit and then heated to expansion temperature,
the microballoons are expanded in the second unit or on exit from the second unit,
the adhesive composition mixture along with the expanded microballoons is formed to a layer in a roll applicator,
the adhesive composition mixture along with the expanded microballoons is optionally applied to a release material in sheet form.

The invention likewise relates to a process for producing a transfer tape of the invention, wherein
the constituents for formation of an adhesive composition, such as polymers, resins or fillers, are mixed in a first mixing unit,
the mixed, especially homogeneous adhesive composition from the first mixing unit is transferred into a second mixing unit, into which the non-expanded microballoons are also introduced,
the microballoons are expanded in the second mixing unit or on exit from the second mixing unit,
the adhesive composition mixture along with the expanded microballoons is formed to a layer in a roll applicator,
the adhesive composition mixture along with the expanded microballoons is optionally applied to a release material in sheet form.

In the hotmelt processes described for production of a transfer tape of the invention, the self-adhesive composition layer may optionally be covered with release material in sheet form, i.e. a liner. Preferably, the self-adhesive composition layer is covered with a liner on both surfaces (subsequently, the transfer tape can optionally be subjected to electron beam curing).

Many units for continuous production and processing of solvent-free polymer systems are known. Usually, screw machines such as single-screw and twin-screw extruders of different processing length and with different equipment are used. Alternatively, continuous kneaders of a wide variety of different designs, for example including combinations of kneaders and screw machines, or else planetary roller extruders, are used for this task. For example, it is advantageous when
the first mixing unit is a continuous unit, especially a planetary roll extruder, a twin-screw extruder or a pin extruder,
the first mixing unit is a batchwise unit, especially a Z kneader or an internal mixer,
the second mixing unit is a planetary roll extruder, a single-screw or twin-screw extruder or a pin extruder and/or
the shaping unit in which the adhesive composition along with the expanded microballoons is shaped to give a carrier layer is a calender, a roll applicator or a gap formed by a roll and a fixed doctor.

Optional degassing is ideally effected directly upstream of the roll applicator at mixing temperature and with a pressure differential from ambient pressure of at least 200 mbar. Particular preference is given to a process in which the first mixing unit is a planetary roll extruder and the second mixing unit is a twin-screw extruder.

It may be particularly advantageous when the second mixing unit in one of the processes detailed above is a planetary roll extruder with a degassing apparatus in the form of a gas-permeable side-arm extruder.

Particular preference is given to a process in which the first mixing unit is a planetary roll extruder and the second mixing unit is a planetary roll extruder with degassing apparatus in the form of a gas-permeable side-arm extruder.

Planetary roll extruders have been known for some time and were first used in the processing of thermoplastics, for example PVC, where they were used mainly for charging of the downstream units, for example calenders or roll systems. Their advantage of high surface renewal for material and heat exchange, with which the energy introduced via friction can be removed rapidly and effectively, and of short residence time and narrow residence time spectrum, has allowed their field of use to be broadened recently, inter alia, to compounding processes that require a mode of operation with exceptional temperature control.

Planetary roll extruders exist in various designs and sizes according to the manufacturer. According to the desired throughput, the diameters of the roll cylinders are typically between 70 mm and 400 mm.

Planetary roll extruders generally have a filling section and a compounding section.

The filling section consists of a conveying screw, into which all solid components are metered continuously. The conveying screw then transfers the material to the compounding section. The region of the filling section with the screw is preferably cooled in order to avoid caking of material on the screw. But there are also embodiments without a screw section, in which the material is applied directly between central and planetary spindles. However, this is of no significance for the efficacy of the process of the invention.

The compounding section consists of a driven central spindle and several planetary spindles that rotate around the central spindle within one or more roll cylinders having internal helical gearing. The speed of the central spindle and hence the peripheral velocity of the planetary spindles can be varied and is thus an important parameter for control of the compounding process.

The materials are circulated between the central and planetary spindles, i.e. between planetary spindles and the helical gearing of the roll section, such that the materials are dispersed under the influence of shear energy and external temperature control to give a homogeneous compound.

The number of planetary spindles that rotate in each roll cylinder can be varied and hence adapted to the demands of the process. The number of spindles affects the free volume within the planetary roll extruder and the residence time of the material in the process, and additionally determines the size of the area for heat and material exchange. The number of planetary spindles affects the compounding outcome via the shear energy introduced. Given a constant roll cylinder diameter, it is possible with a greater number of spindles to achieve better homogenization and dispersion performance, or a greater product throughput.

The maximum number of planetary spindles that can be installed between the central spindle and roll cylinder is dependent on the diameter of the roll cylinder and on the diameter of the planetary spindles used. In the case of use of greater roll diameters as necessary for achievement of throughputs on the production scale, or smaller diameters for the planetary spindles, the roll cylinders can be equipped with a greater number of planetary spindles. Typically, up to seven planetary spindles are used in the case of a roll diameter of D=70 mm, while ten planetary spindles, for example, can be used in the case of a roll diameter of D=200 mm, and 24, for example, in the case of a roll diameter of D=400 mm.

It is proposed in accordance with the invention that the coating of the optionally foamed adhesive compositions be conducted in a solvent-free manner with a multiroll applicator system. These may be applicator systems consisting of at least two rolls with at least one roll gap up to five rolls with three roll gaps.

Also conceivable are coating systems such as calenders (I, F, L calenders), such that the foamed adhesive composition is shaped to the desired thickness as it passes through one or more roll gaps.

The preferred 4-roll applicator is formed by a metering roll, a doctor roll, which determines the thickness of the layer on the carrier material and is arranged parallel to the metering roll, and a transfer roll disposed beneath the metering roll. At the lay-on roll, which together with the transfer roll forms a second roll gap, the composition and the material in sheet form are brought together.

In order to improve the transfer characteristics of the shaped composition layer from one roll to another, it is also possible to use anti-adhesively finished rolls or patterned rolls. In order to produce a sufficiently precisely shaped adhesive film, the peripheral speeds of the rolls may have differences.

Depending on the nature of the carrier material in sheet form which is to be coated, coating can be effected in a co-rotational or counter-rotational process.

The shaping system may also be formed by a gap formed between a roll and a fixed doctor. The fixed doctor may be a knife-type doctor or else a stationary (half-)roll.

The likewise preferred 2-roll application system is formed by two co-rotatory rolls, with supply of an anti-adhesively modified film or release paper or other release or carrier materials via each of the two rolls. The composition is then formed between these release or carrier materials. For example, these may be siliconized PET films of 50 μm in thickness. The two release or carrier materials may be the same or different. In general, a rotating body of composition is formed in the coating gap. The composition can be supplied in the roller gap by means of one or more static or moving feed pipes. The composition can also be introduced via a preliminary distributor nozzle. Optionally, the composition is deposited with or without a free thread of composition onto sheets running into the roller gap. The formed product can be wound up in covered form on both sides, or one of the release or carrier materials can be removed again. These and further release or carrier materials can also be exchanged or swapped inline.

3. Electron Beam Curing of the Pressure-Sensitive Adhesive Strip:

Subsequently, the pressure-sensitive adhesive strip according to Claim 1 can be subjected to electron beam curing, for which a system from ELECTRON CROSSLINKING AB (Halmstad, Sweden) may be used, at an acceleration voltage of 220 keV (matched if required to the desired penetration depth and density of the product) and a suitable dose of, for example, 10 to 100 kGy. Thus, for example, both doses of less than 75 kGy and of greater than 75 kGy are conceivable. Typically, the self-adhesive composition layer is subjected to irradiation with electrons from both sides, i.e. symmetrically, in order to assure homogeneous curing. This is advantageous especially in the case of greater thicknesses of the self-adhesive composition layers to be irradiated. In the case of thin specimens of thickness 50 μm, for example, single-sided irradiation is possible. Preferably, prior to the irradiation, the liner is removed from the appropriate side, especially in order to avoid loss of radiation and damage to the liner. The effect of the latter may especially be that the liner can no longer be pulled off the self-adhesive composition layer after the irradiation. Given suitable technical design, the irradiation operation can be effected inline or in one step in the production process.

Accordingly, the present invention also relates to a process for producing a pressure-sensitive adhesive strip as defined above, in which the self-adhesive composition is processed from solution or from the melt to give layer SK1, and layer SK1 is optionally then subjected to irradiation with electrons. The process can be conducted without the use of a crosslinking promoter, which lowers the cost and complexity in the production of the pressure-sensitive strip of the invention.

### Use of the Pressure-Sensitive Adhesive Strip of the Invention

By contrast with point welding, the pressure-sensitive adhesive strip of the invention allows the simple bonding both of identical and of different materials. In the bonding of two different plastics or other materials with different weld points by welding, weak points in the material can occur through burning, or the joining is incomplete since one material does not flow sufficiently to the weld point and bond to the other. In the case of bonding with the pressure-sensitive adhesive strip of the invention, different material properties are no longer significant.

The pressure-sensitive adhesive strip of the invention (unirradiated or irradiated with electrons) has the beneficial features, for example, not only of good adhesion to polar surfaces but especially also of good adhesion to low-energy, i.e. non-polar surfaces (LSE (low-surface energy) surfaces). Since no adhesion promoter or primer is needed here, bonding is thus possible without substrate pretreatment. It can thus especially be used for bonding of nonpolar surfaces, i.e. for bonding of surfaces having a surface energy of 50 mN/m or less, preferably less than 40 mN/m, and especially less than 35 mN/m. Especially in applications in the automotive sector, plastics are being used ever more frequently in place of metals. These generally have a low surface energy that frequently makes it difficult to bond them to these substrates. This can be remedied by means of the pressure-sensitive adhesive strip of the invention. The nonpolar surfaces that can be bonded in accordance with the invention include, for example, those based on fluorinated polymers, for example Teflon, organosilicon polymers, polyolefins, for example polyethylene, polypropylene, EPDM or a polypropylene-EPDM composite, ethylene-vinyl acetate copolymers, polyvinylaromatics such as polystyrene or copolymers based on styrene (e.g. styrene-butadiene block copolymers, acrylonitrile-butadiene-styrene copolymers), polyvinylacetate, polyacrylates such as polymethylmethacrylate, polycarbonate, polyurethanes, polyamides, polyesters such as polyethylene terephthalate, cellulose acetate, ethyl cellulose, or based on polymers containing segments of the aforementioned polymers, or those based on a mixture of the aforementioned polymers, optionally with further polymers. In this context, the wording “based on the polymer” typically means that predominantly the said polymer assumes the function of the surface material. Typically, the said polymer is provided as the sole polymer in the surface material or in any case, however, to an extent of at least 50% by weight based on the total content of all polymer components. Resins are not considered to be polymers in this context. However, the pressure-sensitive adhesive strip is also suitable for bonding of other substrates as polymer material, for example glass or ceramic material, metal, for example stainless steel, metal oxide or combinations thereof. The materials here may be in pure form or have been blended or filled with other materials. In addition, the material may be recycled material or a functional substance, for example for increasing/lowering conductivities or tactile properties.

The pressure-sensitive adhesive strip of the invention is suitable for permanent bonding of two components made of identical or different materials. It is possible to use all conceivable materials, preferably as listed above. Preference is given to stiff materials such as metals or plastics having a high stiffness modulus, or else plastics stiffened with, for example, glass fibres or other strength members.

The pressure-sensitive adhesive strip of the invention is therefore suitable for a wide variety of different industrial applications; preference is given to using it for interior applications, and in that case especially in the construction, automotive or electronics sector.

The pressure-sensitive adhesive strip can be used, for example, in the automotive interior sector, and in that case especially in doors, such as interior doors, cockpits, centre consoles, seats and other parts wherein the base structure or individual parts are bonded to one another. It can also be used, for example, in automobile bodywork side mouldings, rear-view mirrors, outer cladding parts, weather strips, road signs, trade signs, constructions, control cabinets, shell moulds, machine parts, connection sockets or backsheet solutions for photovoltaic modules (i.e. in the solar cell industry). In addition, it can be used for bonding to automotive dearcoat surfaces, such as, in particular, clearcoats for motor vehicles such as a car. The substrate to which the pressure-sensitive adhesive strip can be applied is selected depending on the particular use. For example, the pressure-sensitive adhesive strip can be applied to film products (e.g. decorative graphics and reflective products), label materials and tape carriers. In addition, it can be applied directly to other substrates, for example a metal plate (e.g. a motor vehicle panel) or a glass window, such that another substrate or object can be mounted on the plate or the window.

The invention correspondingly includes semifinished products or add-on parts equipped with a pressure-sensitive adhesive strip of the invention. If semifinished products or add-on parts are correspondingly prepared, integration into the final bonding process on the production line is particularly efficient.

If the pressure-sensitive adhesive strip is being laminated onto the substrate, it may be desirable to treat the surface of the substrate and/or of the pressure-sensitive adhesive strip in order to further improve the adhesion. Such treatments are typically selected on the basis of the type of materials in the pressure-sensitive adhesive strip and in the substrate and include primer treatment and surface modifications, for example corona treatment and surface abrasion. More particularly, the pressure-sensitive adhesive strip and/or the surfaces to be bonded may have been coated with a primer in order to achieve better adhesion of the pressure-sensitive adhesive strip on the surfaces to be bonded. The substrate and/or the pressure-sensitive adhesive strip may likewise have been subjected to a plasma treatment. Owing to the good adhesion of the pressure-sensitive adhesive strip of the invention not merely to polar surfaces but also to nonpolar surfaces, however, this is generally unnecessary. The pressure-sensitive adhesive strip therefore has the advantage that it can typically be used for bonding of different surfaces without use of a primer.

The bonding of surfaces, especially of low-energy services, can surprisingly be effected using, i.e. by means of, the pressure-sensitive adhesive strip of the invention even at low temperatures, for example at a temperature of not more than 10° C., preferably of not more than 5° C. and especially of not more than 0° C. The pressure-sensitive adhesive strip of the invention can thus be used for convenient bonding of surfaces even in a cold environment, for example in production halls or in workshops. More particularly, two components can be joined, i.e. bonded, here. Preferably, the two components have different surface energies. The surprising suitability for adhesive bonding at low temperatures is demonstrated in the examples.

The invention further provides a process for bonding components, in which the components are mechanically bonded, for example welded, and simultaneously adhesive-bonded by means of the pressure-sensitive adhesive strip of the invention.

Owing to the good adaptability of the pressure-sensitive adhesive strip, it is particularly suitable for bonding over steps, weld seams and other topologies. Owing to the high immediate bonding force and good resistance to detachment, reliable bonding can be achieved over such surface topologies as well.

In addition, the pressure-sensitive adhesive strip of the invention has very high tensile strength, tensile shear strength and facial tensile strength. For example, in a tensile test or shear test of two 3 mm-thick PP/EPDM test substrates bonded with the pressure-sensitive adhesive strip of the invention, the test substrate can be deformed or destroyed before fracture of the bond occurs.

As well as the bonding of nonpolar substrates or paints, the adhesive tape of the invention is especially also suitable for bonding of oil-contaminated substrates, for example metal sheets. It is particularly important here that there is no restriction in the bonding force on such critical substrates and, consequently, crosslinking of the adhesive tape does not seem obvious or feasible. At the same time, in general, in the case of bonding of metal sheets, for example, for construction purposes, there must be high shear strength at high temperature. The surprising suitability for adhesive bonding on oiled metal sheets is demonstrated in the examples.

A further preferred option is the bonding of two components that have additional positioning pins within the mouldings but are held together by means of the adhesive tape.

The very rapid initial adhesion of the adhesive tape on various substrates, even on low-energy surfaces, enables rapid automated application even to plastics. Such plastics occur especially in the automotive interior sector, and especially in doors, such as interior doors, cockpits, centre consoles, seats and other parts wherein the base skeleton or individual parts are bonded to one another. The adhesive tape is also suitable for bonding of add-on parts or decorative parts that are mounted outside or inside the car. Typically, a plastics part is bonded here to a painted surface, for example an EPDM add-on part to a low-energy clearcoat on a metal sheet.

### FIGURE

With reference to the FIGURE described hereinafter, a particularly advantageous execution of the invention will be elucidated in detail, without any intention to unnecessarily restrict the invention thereby.

FIG. 1 shows the schematic construction of a single-layer pressure-sensitive adhesive strip of the invention, consisting of one layer 2 in cross section.

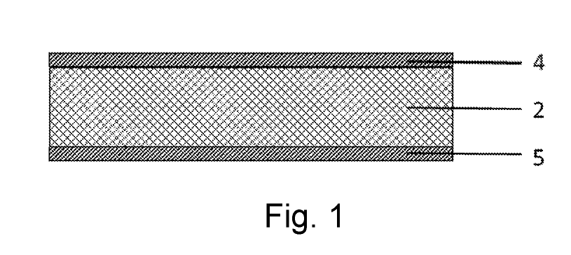

The strip comprises a self-adhesive composition layer 2 (layer SK1). The self-adhesive composition layer 2 (layer SK1) is covered by a liner 4, 5 on each side in the illustrative embodiment shown.

The invention is elucidated in detail hereinafter by examples. With reference to the examples described hereinafter, particularly advantageous executions of the invention will be elucidated in detail, without any intention to unnecessarily restrict the invention thereby.

### EXAMPLES

The raw materials used are characterized as follows:
Kraton® D1101: styrene-butadiene-styrene triblock copolymer from Kraton Polymers with 16% by weight of diblock, block polystyrene content: 31% by weight, proportion of 1,2-bonded conjugated diene in the butadiene block: 10% by weight
Kraton® D1118: styrene-butadiene-styrene triblock copolymer from Kraton Polymers with 78% by weight of diblock, block polystyrene content: 33% by weight, proportion of 1,2-bonded conjugated diene in the butadiene block: 10% by weight
Dercolyte A115: solid α-pinene tackifying resin with a ring and ball softening temperature of 115° C. and a DACP of 35° C.
Piccolyte® A25: polyterpene resin based on α-pinene with a ring and ball softening temperature of 22 to 28° C.
Escorez 2203: hydrocarbon resin based on C5 and C9 with low aromatics content, softening point (ring & ball) 95° C.
Expancel 920 DU40, Expancel 920 DU80: unexpanded microballoons.
Ebecryl 140: di(tnmethylolpropane) tetraacrylate

Table 1 shows the composition of the adhesive composition formulations used.

TABLE 1
Composition of the adhesive composition formulations
used (figures in parts by weight).

| | R1 | R2 | R3 | R4 |
|---|---|---|---|---|
| Kraton D 1101 | 25 | 25 | 20 | 20 |
| Kraton D 1118 | 25 | 25 | 30 | 30 |
| Escorez 2203 | | | 50 | |
| Dercolyte A115 | 50 | 48 | | 50 |
| Piccolyte A25 | | 2 | | |
| Expancel 920DU40 | 3 | 3 | | |
| Expancel 920DU80 | | | 3 | 3 |

### Process V1 (Solution Process):

For this purpose, first of all, a 40% by weight adhesive solution of the formulation specified in each case in benzine/toluene/acetone was prepared. The proportions by weight of the dissolved constituents are each based on the dry weight of the resulting solution.

The solution was subsequently admixed if required with unexpanded microballoons, using the microballoons in the form of a suspension in benzine. The proportion by weight of the microballoons is based on the dry weight of the solution used to which they have been added (i.e. the dry weight of the solution used is fixed at 100%). The mixture obtained was then coated with a coating bar onto a PET liner provided with a silicone release agent in the desired layer thickness, then the solvent was evaporated off at 100° C. for 15 min and so the composition layer was dried. Thereafter, a second PET liner of this kind was laminated onto the free surface of the dried adhesive composition layer produced and the adhesive composition layer was then foamed between the two liners in an oven at 150° C. for 5 min, so as to obtain a pressure-sensitive adhesive strip of the invention of thickness about 100 μm. If required, the target thickness was established by multiple lamination of this layer. Die-cutting gave the desired dimensions.

### Process V2 (Hotmelt Process):

The elastomer components were added in the intake of the PRE (planetary roll extruder), which comprised an intake region and two process parts. The run-in rings had increasing diameter in process direction. Even though different spindle fittings were suitable, preference was given to fittings that were at least % of the maximum fitting number in the first process part. The resin components were melted and added in the second process part of the PRE. A particularly suitable means of production of homogeneous mixtures was a resin split in which one portion of the resin was added in the first process part and the rest downstream in the second process part. A particularly suitable means of addition of the two components was in liquid form via a side feed or run-in rings, where the first portion is about 10% of the total amount of resin, and the process was executed in such a way unless stated otherwise. Another suitable option would have been the addition of the first resin component in solid form in the intake of the PRE or via the side feed in the first process part. The compounded composition was transferred into the twin-screw extruder by a heated hose. Microballoons were added via a side feed in the first third of the TSE (twin-screw extruder) and foamed therein, such that the foaming had essentially ended before exit from the unit. As a result of heat of friction, the melt temperature in the TSE was always above the wall temperatures set. At the end of the TSE, a vacuum was applied at a suitable point. The melt exit temperature was about 130° C. The melt was then transferred via a pre-distribution nozzle (coathanger nozzle) into a two-roll calender and formed between two double-sidedly siliconized 50 μm PET films. This advantageous process always achieved roughnesses Rₐ<5 μm (measured by means of white light interferometry).

Table 2 shows the parameters of the hotmelt process.

TABLE 2
Parameters of the hotmelt process (L/D = length/diameter).

| Total throughput of elastomer components | 20 | kg/h |
|---|---|---|
| Roll cylinder diameter | 70 | mm |
| PRE central spindle temp. | 50° | C. |
| PRE zone temps | 90° C./90° C./90° C./90° C. | |
| PRE speed | 100/min | |
| Diameter of TSE screws and L/D | 42 mm, 36 L/D | |
| TSE zone temps | 20° C./50° C./80° C./80° C. | |
| TSE speed | 100/min | |
| TSE vacuum | 200 | mbar |

| | |
|---|---|
| Calendering roll temps | 120° C./120° C. |

There follows a description of the production of a pressure-sensitive adhesive strip of the invention which consists of a single foamed self-adhesive composition layer SK1 (transfer tape) based on vinylaromatic block copolymer foamed with microballoons. The self-adhesive composition layer SK1 can be produced without use of a soft resin (Example B1), or with use of such a resin (Example B2). Example B3 corresponds to Example B2, but produced by the hotmelt process V2. Example B4 corresponds to B3, but with Escorez 2203 resin and another elastomer mixture. Example B5 corresponds to B3, but with another elastomer mixture; see also the remarks below.

Table 3 gives an overview of examples B1 to B5 as a combination of different formulations and processes.

TABLE 3
Overview of the formulations and production
processes used in Examples B1 to B5.

| Example | Formulation | Process |
|---|---|---|
| B1 | R1 | V1 |
| B2 | R2 | V1 |
| B3 | R2 | V2 |
| B4 | R3 | V2 |
| B5 | R4 | |

In each case, as described, the self-adhesive composition layer SK1 was subsequently irradiated with electrons.

### Example B1

The pressure-sensitive adhesive strip was produced by process V1 using formulation R1, in such a way that it has a thickness of about 1000 μm. The thickness is always based on the pressure-sensitive adhesive strip without PET liner.

### Example B2

The production of the pressure-sensitive adhesive strip from Example B2 differs from the production of the pressure-sensitive adhesive strip from Example B1 merely in that the 40% by weight adhesive solution used also contains 2% by weight of Piccolyte® A25, based on the dry weight of the resulting solution.

### Examples B3-B5

Example B3 was produced with the formulation of B2, but by the hotmelt process V2. Examples B4 and B5 were produced like B3, but with the formulations as specified in Table 3.

Irradiation with Electrons of Examples B1 to B5:

The self-adhesive composition layer SK1 of the pressure-sensitive adhesive strip from Example B1-B5 was subsequently subjected to electron beam curing, using a system from ELECTRON CROSSLINKING AB (Halmstad, Sweden). The acceleration voltage was 220 keV. The dose was varied in each case within the range from 10 to 100 kGy in steps of 10 kGy. The self-adhesive composition layer was subjected here to irradiation with electrons from both sides, i.e. symmetrically, in order to assure homogeneous curing. Prior to the irradiation, the liner was removed on the side to be irradiated in each case. An unirradiated reference specimen was always also produced.

### Results for Examples B1 to B5:

### Example 1

The pressure-sensitive adhesive strip (containing no soft resin) from Example B1 that has been subjected to the specified doses of electron radiation was tested in each case for its lifetime under high-temperature shear by means of the static shear test (dimensions of the test strip: length 25 mm, width 25 mm, measurement temperature: 80° C., load 500 g). Without electron irradiation the lifetime under high-temperature shear was already more than 2000 min, at a radiation dose of 40 or 60 kGy it was about 2600 min, at a radiation dose of 80 kGy it was about 8000 min, and at a radiation dose of 100 kGy the sample strip still had not yet sheared off even after 10 000 min. It was thus possible to increase the lifetime under high-temperature shear with increasing radiation intensity; the result (even without additional crosslinking promoter) was very good lifetimes under high-temperature shear. The gel content of the self-adhesive composition layer SK1 at all irradiation intensities was found in each case to be 0% by weight, meaning that no macroscopic crosslinking could be observed.

The bonding force of the unirradiated pressure-sensitive adhesive strip was about 28 N/cm. The bonding force (and also the tensile strength) of the pressure-sensitive adhesive strip also remained essentially unchanged on irradiation with electrons (different dose).

### Example 2

The pressure-sensitive adhesive strip (containing Piccolyte® A25 as soft resin) from Example B2 that has been subjected to the specified doses of electron radiation was likewise tested in each case for its lifetime under high-temperature shear by means of the static shear test (dimensions of the test strip: length 13 mm, width 20 mm, measurement temperature: 70° C., load 500 g). Without electron irradiation, the lifetime under high-temperature shear was already about 3400 min. Even from a radiation dose of 10 kGy (and up to a radiation dose of 100 kGy), the sample strip still had not sheared off even after 10 000 min. The slip travel of the test specimen after 10 000 min was, for example, at radiation doses of 10 kGy, 20 kGy, 30 kGy and 40 kGy, 4.8 mm, 2.8 mm, 2.7 mm and 2.0 mm respectively. In the case of a pressure-sensitive adhesive strip comprising soft resin, it was thus possible to increase heat resistance with increasing irradiation intensity, and the result (even without additional crosslinking promoter) was very good heat resistances. The gel content of the self-adhesive composition layer SK1 was found in each case to be 0% by weight; in other words, no macroscopic crosslinking was observed. The use of soft resin is therefore not a barrier to the achievement of high heat resistances.

The bonding force of the unirradiated pressure-sensitive adhesive strip was about 34 N/cm; in other words, it was increased by the use of soft resin. The bonding force (and also the tensile strength) of the pressure-sensitive adhesive strip also remained essentially unchanged on irradiation with electrons (different dose).

### Example B3

Example B3 was tested in the same way as Example B2. The gel content even after EBC irradiation at the doses specified was found to be 0% by weight in each case. Without EBC irradiation, the lifetime under high-temperature shear in the static shear test at 70° C. was 4000 min. Over and above a dose of 20 kGy, the lifetime under shear was >10 000 min.

### Example B4

Example B4 was tested in the same way as Example B2. The gel content even after EBC irradiation at the doses specified was found to be 0% by weight in each case. Without EBC irradiation, the lifetime under high-temperature shear in the static shear test at 70° C. was 1200 min. Over and above a dose of 20 kGy, the lifetime under shear was >10 000 min.

### Example B5

Example B5 was tested in the same way as Example B2. The gel content even after EBC irradiation at the doses specified was found to be 0% by weight in each case. Without EBC irradiation, the lifetime under high-temperature shear in the static shear test at 70° C. was 5400 min. Over and above a dose of 20 kGy, the lifetime under shear was >10 000 min.

### Examples 6 to 8 (Including Results)

There follows a description of the production of a foamed self-adhesive composition layer SK1 of the invention of about 500 μm in thickness, which was produced in Examples B6-B8 with formulation R1 by the hotmelt process V2. These examples contained the proportion of Ebecryl 140 crosslinking promoter specified in each case in Table 4. Examples B6-B8 were each produced with and without irradiation with electrons, as specified in Table 4.

TABLE 4
Overview of Examples 6 to 8 (including results).

| | | | | EBC | | | |
|---|---|---|---|---|---|---|---|
| | Base | Cross- | | dose | LSS | BF 90° | |
| | formu- | linking | Production | [kGy, at | 70° C. | ASTM | Gel |
| | lation | promoter | process | 170 kV] | [min] | [N/cm] | value |
| B6 | R1 | 0% | V2 | 0 | 4592 | 22.7 | 0% |
| B6 | R1 | 0% | V2 | 50 | 10 000 | 17.3 | 0% |
| B7 | R1 | 1% | V2 | 0 | 3564 | 20.8 | 0% |
| B7 | R1 | 1% | V2 | 50 | 10 000 | 13.0 | 15% |
| B8 | R1 | 3% | V2 | 0 | 460 | 18.6 | 0% |
| B8 | R1 | 3% | V2 | 50 | 10 000 | 11.2 | 11% |

LSS = lifetime under shear stress.
BF = bonding force.

The table shows that a high lifetime under shear stress can be achieved at 70° C. by means of EBC even without crosslinking promoter, and, furthermore, the use of the crosslinking promoter is disadvantageous since the bonding force is noticeably lowered even at low gel values (11% or less). The pressure-sensitive adhesive compositions of the invention thus preferably have a gel value of 0% after EBC treatment. More particularly, in the EBC treatment of the invention without crosslinking promoter, the bonding force after EBC treatment reaches at least 75% of the original value without EBC treatment, and/or the dose of the EBC treatment is selected such that the bonding force after EBC treatment reaches at least 75% of the original value without EBC treatment.

### Bonding on Oiled Substrates:

For testing of suitability for bonding on oiled substrates, the adhesive tapes, as specified in Table 5, were bonded to steel sheets having 4 g/m² of oil (Quaker 61AUS). Comparative adhesive tape 1 is a double-sided acrylate adhesive tape of 500 μm in thickness, produced according to Example MT15 from DE 10 2009 048036 A1. Comparative adhesive tape 2 is the commercially available product Tesa© 4954, i.e. a double-sided adhesive tape of about 430 μm in thickness with natural rubber adhesives.

It can be seen that the an adhesive tape of the invention according to Example B6 (but produced with irradiation intensity 20 kGy) has excellent bonding force on the oiled substrate.

TABLE 5
Bonding force on oiled substrate.

90° bonding force [N/cm]

| | Comparative | Comparative | |
|---|---|---|---|
| Attachment time | adhesive | adhesive | B6 with |
| [min] | tape 1 | tape 2 | EBC 20 kGy |
| 2 | 0.02 | 0.23 | 0.80 |
| 60 | 0.05 | 0.77 | 3.85 |
| 240 | 0.24 | 1.30 | 9.23 |

### Bonding at Low Temperatures:

For testing of suitability for bonding at low temperatures, the adhesive tapes, as specified in Table 6, were bonded to ASTM steel at 0°. Comparative adhesive tape 1 is a double-sided acrylate adhesive tape of 500 μm in thickness, produced according to Example MT15 from DE 10 2009 048036 A1. The bonding forces were measured as described in the test methods, except that the attachment time and measurement were each effected at 0° C.

It can be seen that the adhesive tape of the invention according to example B5 has excellent bonding force at 0° C.

TABLE 6
Bonding at 0° C.

| | | Bonding force 90° [N/cm], measured at 0° C. | |
|---|---|---|---|
| | | Comparative | |
| Attachment time | | adhesive | B5 with |
| at 0° C. | | tape 1 | EBC 20 kGy |
| 2 | min | 1 | 31 |
| 24 | h | 19 | 37 |

### Test Methods

Unless stated otherwise, all measurements were conducted at 23° C. and 50% rel. air humidity.

The mechanical and adhesive data were ascertained as follows:

### DACP

5.0 g of test substance (the tackifier resin sample to be examined) are weighed into a dry test tube, and 5.0 g of xylene (isomer mixture, CAS [1330-20-7], ≥98.5%, Sigma-Aldrich #320579 or comparable) are added. The test substance is dissolved at 130° C. and then cooled down to 80° C. Any xylene that escapes is made up for with fresh xylene, such that 5.0 g of xylene are present again. Subsequently, 5.0 g of diacetone alcohol (4-hydroxy-4-methyl-2-pentanone, CAS [123-42-2], 99%, Aldrich #H41544 or comparable) are added. The test tube is shaken until the test substance has dissolved completely. For this purpose, the solution is heated to 100° C. The test tube containing the resin solution is then introduced into a Novomatics Chemotronic Cool cloud point measuring instrument and heated therein to 110° C. It is cooled down at a cooling rate of 1.0 K/min. The cloud point is detected optically. For this purpose, that temperature at which the turbidity of the solution is 70% is registered. The result is reported in ° C. The lower the DACP value, the higher the polarity of the test substance.

### Tackifying Resin Softening Temperature

The softening temperature of a tackifying resin is determined in accordance with the relevant methodology, which is known as ring & ball and is standardized according to ASTM E28.

### Diameter

The average diameter of the voids formed by the microballoons in a self-adhesive composition layer is determined using cryofracture edges of the pressure-sensitive adhesive strip in a scanning electron microscope (SEM) with 500-fold magnification. The diameter of the microballoons in the self-adhesive composition layer to be examined that are visible in scanning electron micrographs of 5 different cryofracture edges of the pressure-sensitive adhesive strip is determined in each case by graphical means, and the arithmetic mean of all the diameters ascertained in the 5 scanning electron micrographs constitutes the mean diameter of the voids formed by the microballoons in the self-adhesive composition layer in the context of the present application. The diameters of the microballoons visible in the micrographs are determined by graphical means in such a way that the maximum extent thereof in any (two-dimensional) direction is inferred from the scanning electron micrographs for each individual microballoon in the self-adhesive composition layer to be examined and regarded as the diameter thereof.

### Density

The density of a pressure-sensitive adhesive composition layer is ascertained by forming the quotient of mass applied and thickness of the adhesive composition layer applied to a carrier or liner.

The mass applied can be determined by determining the mass of a section, defined in terms of its length and width, of such an adhesive composition layer applied to a carrier or liner, minus the (known or separately determinable) mass of a section of the same dimensions of the carrier or liner used.

The thickness of an adhesive composition layer can be determined by determining the thickness of a section, defined in terms of its length and width, of such an adhesive composition layer applied to a carrier or liner, minus the (known or separately determinable) thickness of a section of the same dimensions of the carrier or liner used. The thickness of the adhesive composition layer can be determined by means of commercial thickness measuring instruments (caliper test instruments) with accuracies of less than a 1 μm deviation. In the present application, the Mod. 2000 F precision thickness gauge is used, which has circular calipers having a diameter of 10 mm (planar). The measurement force is 4 N. The value is read off 1 s after applying load. If variations in thickness are found, the average of measurements at at least three representative sites is reported, i.e. more particularly not measured at creases, folds, specks and the like.

### Thickness

Like the thickness for an adhesive composition layer as above, it is also possible to ascertain the thickness of a pressure-sensitive adhesive strip or a film carrier layer or liner by means of commercial thickness measuring instruments (caliper test instruments) with accuracies of less than a 1 μm deviation. In the present application, the Mod. 2000 F precision thickness gauge is used, which has circular calipers having a diameter of 10 mm (planar). The measurement force is 4 N. The value is read off 1 s after applying load. If variations in thickness are found, the average of measurements at at least three representative sites is reported, i.e. more particularly not measured at creases, folds, specks and the like.

### Static Glass Transition Temperature T_{g}, Melting Temperature, Softening Temperature

Glass transition points—referred to synonymously as glass transition temperatures—particularly of polymers or polymer blocks are reported as the result of measurements by means of differential scanning calorimetry (DSC) according to DIN 53 765; especially sections 7.1 and 8.1, but with uniform heating and cooling rates of 10 K/min in all heating and cooling steps (cf. DIN 53 765; section 7.1; note 1). The sample weight is 20 mg. The melting temperature or softening temperature of polymers or polymer blocks is also determined in this way.

### Proportion of 1,2-Bonded Conjugated Diene

The proportion of 1,2-bonded conjugated diene in the B block of vinylaromatic block copolymer can be determined by means of ¹H NMR. The following instrument was used for spectroscopic analysis: ¹H NMR: Bruker AMX 500 (500.14 MHz). The standard used was the solvent signal δ (CHCl3)=7.24. Chemical shifts are always reported in ppm. Coupling constants J are reported in hertz [Hz]. Signal patterns are reported as follows: s (singlet), bs (broad singlet), d (doublet), dd (doublet of doublets), t (triplet), q (quintet), m (multiplet).

### Surface Energies

Surface energies (surface tensions) are determined according to DIN ISO 8296. For this purpose, it is possible to use, for example, test inks from Softal. The inks are available in the range from 30 to 72 mN/m. The ink is applied to the surface with a stroke of ink at 23° C. and 50% rel. air humidity. If the stroke of ink draws together within less than 2 seconds, the measurement is repeated with ink having lower surface energy until 2 seconds are attained. If the stroke of ink remains unchanged for longer than 2 seconds, the measurement is repeated with ink having higher surface energy until 2 seconds are attained. The value specified on the appropriate bottle of ink then corresponds to the surface energy of the substrate.

### Lifetime Under High-Temperature Shear—Static Shear Test SST

To determine the lifetime under high-temperature shear, also called high-temperature shear strength, a pressure-sensitive adhesive strip in a climate-controlled cabinet heated to 70° C. or 80° C. is applied to a defined rigid bonding substrate (steel here) and subjected to constant shear stress. The hold time in minutes is ascertained. The temperatures used are stated in the examples.

A double-sidedly adhesive strip of length 13 mm and width 20 mm or of length 25 mm and width 25 mm of the pressure-sensitive adhesive strip to be tested is manually applied to a polished small steel plate (test substrate) having a hole at one end. Subsequently, an identical small steel plate is manually applied in the reverse orientation. The resulting composite is compressed at 100 N/cm² for 60 seconds (in the case of the 20×13 mm geometry the force is 0.260 kN; in the case of the 25×25 mm geometry the force is 0.625 kN.

The attachment time between roll-on and application of load should be 24 h, unless stated otherwise in the examples. Before applying load, the sample is subjected to heat treatment in a heated cabinet for 15 minutes. The weight is then hung on with the aid of S-shaped hooks, and was 500 g unless stated otherwise. The loads used in kPa or N/cm² bond area are reported in the examples.

An automatic stopwatch then ascertains the juncture at which the test specimens shear off. The measurement is stopped after 10 000 min. In the case of test specimens that have still not dropped after 10 000 min, the quality of the cohesive properties at high temperature can also be quantified by determining the slip travel or the deflection without slippage of the test specimen after 10 000 min by means of a position sensor.

The average from three measurements is ascertained.

### 90° Bonding Force (BF)

Unless stated otherwise, the 90° bonding force is determined on steel, under controlled test conditions of temperature 23° C.+/−1° C. and relative air humidity 50%+/−5%. The specimens are cut to width 20 mm and bonded to the steel substrate. Unless stated otherwise, the substrate is cleaned and conditioned prior to the measurement. For this purpose, the plate is first wiped with acetone and then left to dry under air for 5 minutes in order that the solvent can evaporate off. The side of the pressure-sensitive adhesive tape remote from the test substrate is then covered with a 50 μm aluminium foil, which prevents the specimen from stretching in the measurement. Thereafter, the test specimen is rolled onto the test substrate. For this purpose, a 2 kg roll is rolled over the tape five times back and forth at a rolling speed of 10 m/min. Immediately after the roll-on, the substrate is pushed into a special holder that enables the specimen to be drawn vertically upward at an angle of 90°. The bonding force is measured with a Zwick tensile tester. The test results are reported in N/cm and averaged from three measurements.

### Determination of Gel Content

The carefully dried solvent-free adhesive samples are welded into a small bag of polyethylene nonwoven fabric (Tyvek nonwoven). The difference in the sample weights before and after extraction by a mixture of benzine/toluene/acetone is used to determine the gel value, i.e. the proportion by weight of the polymer insoluble in the mixture. Additives that are not incorporated into the network even after EBC irradiation have to be subtracted from the total sample weight before the extraction.

1. A pressure-sensitive adhesive strip containing at least one layer SK1 of a self-adhesive composition based on vinylaromatic block copolymer and containing tackifying resin, wherein the vinylaromatic block copolymer
contains at least one polymer block A formed predominantly by polymerization of vinylaromatics, and
simultaneously contains at least one polymer block B formed predominantly by polymerization of conjugated dienes, where the proportion of 1,2-bonded conjugated diene in the B block is less than 30% by weight.

2. The pressure-sensitive adhesive strip according to claim 1,
wherein,
at least the layer SK1 has been subjected to irradiation with electrons, where the layer SK1 after the irradiation preferably has a gel value of 0%.

3. The pressure-sensitive adhesive strip according to claim 1, wherein
the self-adhesive composition of layer SK1 is foamed.

4. The pressure-sensitive adhesive strip of claim 2, wherein
the absolute density of the self-adhesive composition layer SK1 is 400 to 990 kg/m³.

5. The pressure-sensitive adhesive strip according to claim 1, wherein
the vinylaromatic block copolymer is a mixture of linear block copolymers which comprise a mixture of diblock copolymers (A-B) and triblock copolymers (A-B-A), where the vinylaromatic block copolymer has a diblock copolymer content of 30% to 60% by weight.

6. The pressure-sensitive adhesive strip according to claim 1, wherein
the tackifying resin of layer SK1 comprises, to an extent of at least 75% by weight, hydrocarbon resin or terpene resin or a mixture of thereof.

7. The pressure-sensitive adhesive strip according to
according to claim 3, wherein the foamed layer SK1 comprises microballons in an amount of up to 12% by weight, based on the overall composition of the layer.

8. A process of producing the pressure-sensitive adhesive strip of claim 1, wherein the self-adhesive composition is processed from solution or from the melt to produce layer SK1, and optionally, wherein the layer SK1 is subjected to irradiation with electrons.

9. The process of claim 8,
wherein
the self-adhesive composition is processed from the melt to give layer SK1 using at least one first continuous compounding unit.

10. A process of producing a pressure-sensitive adhesive composition according to claim 1, based on block copolymers with hard block-soft block architecture, where the hard blocks are softenable or meltable at a temperature T (measured by means of DSC), wherein the process is conducted in a planetary roll extruder, and wherein the planetary roll extruder, downstream of the addition of the components of the adhesive composition, has a degassing apparatus in the form of a gas-permeable side-arm extruder.

11. A method of bonding surfaces having a surface energy of 50 mN/m or less, the method comprising the step of:
utilizing the pressure-sensitive adhesive strip of claim 1 in bonding said surfaces.

12. A method of bonding two surfaces, where one of the surfaces has a surface energy of 50 mN/m or less, and the other surface has a surface energy of 35 mN/m or more, the method comprising the step of:
utilizing the pressure-sensitive adhesive strip of claim 1 in bonding said surfaces.

13. A method of bonding two components, the method comprising the step of:
utilizing the pressure-sensitive adhesive strip of claim 1 to bond the two components, wherein the said pressure-sensitive adhesive strip is double-sided, and bonding takes place at a temperature of not more than 10° C.

14. A method of bonding components utilizing the pressure-sensitive adhesive strip of claim 1, wherein the components are simultaneously mechanically bonded, and are also adhesively-bonded with the pressure-sensitive adhesive strip.

15. A method of bonding oil-contaminated substrates, the method comprising the step of: utilizing the pressure-sensitive adhesive strip of claim 1 in bonding the oil-contaminated substrates.

16. The pressure-sensitive adhesive strip, where the proportion of 1,2-bonded conjugated diene in the B block is less than 20% by weight.

17. The pressure-sensitive adhesive strip of claim 4, wherein
the absolute density of the self-adhesive composition layer SK1 is 450 to 800 kg/m³.

18. The pressure-sensitive adhesive strip of claim 17, wherein
the absolute density of the self-adhesive composition layer SK1 is 500 to 700 kg/m³.
